(19) United States
(12) Patent Application Publication
(10) Pub. No.: US 2009/0204543 A1
(43) Pub. Date: Aug. 13, 2009

(54) SYSTEM AND METHOD OF SELECTIVELY DISTRIBUTING MEDIA CONTENT TO A CONSUMER AND PREVENTING THE UNAUTHORIZED SHARING OF MEDIA CONTENT

(76) Inventors: HENRY JOSE SALAZAR MOURE, Miami, FL (US); Cruz Martinez, Corpus Christi, TX (US)

Correspondence Address: RUBEN ALCOBA, ESQ., 3399 NW 72 AVENUE, SUITE211, MIAMI, FL, 33122, US

(21) Appl. No.: 12/196,109

(22) Filed: Aug. 21, 2008

Related U.S. Application Data
(63) Continuation-in-part of application No. 12/069,405, filed on Feb. 11, 2008.

(51) Int. Cl. G06Q 50/00

(52) U.S. Cl. 705/51

(57) ABSTRACT

The present invention is a system and method of selectively distributing media content to consumers, the system comprising essentially of a USB-type storage device loaded with media content, a network and a user interface system. The method comprises essentially of providing a USB-type storage device loaded with media content, distributing the device to retail outlets, instructing a user to contact a network that is in electronic communication with the USB-type storage device, selectively registering the media content on the network, activating the USB-type storage device, displaying the activated media content to the consumer on a display device associated with the user interface system, and providing a means to upload media content onto the USB-type storage device in the event the media content becomes corrupted or erased.

### BACKGROUND

This application is being filed as a Continuation In Part of application Ser. No. 12/069,405 filed on Feb. 11, 2008 pursuant to 37 C.F.R. 1.53(b)(2).

The present invention relates to systems and methods of distribution, specifically to systems and methods of selectively distributing media content to a consumer and preventing the unauthorized sharing of the media content.

It is increasingly becoming more and more difficult for artists in the performing entertainment industry to get the opportunity to work with and sign with producers and label companies. This phenomenon is due largely in part by the fact that musical and video content is indiscriminately and illegally exchanged at little to no cost via the Internet or through other illegal pirating methods of sharing artists work. Such illegal methods of sharing artistic work have caused a dramatic drop in the sales of music and videos in the traditional Compact Disk (CD) and Digital Video Disk (DVD) formats.

As a result of the decline in sales of CD's and DVD's, the entertainment industry has been forced to reduce its workforce; the economic impact has been felt in all levels of the industry, ranging from the artists themselves to the executives of the record labels and album manufactures. As a result of such a decline in sales, the entertainment industry has found itself in a position where there is a surplus of unsold CD's and DVD's numbering in the millions of units.

As technology advances, it is becoming apparent that one of the contributing factors towards the decline of sales of the traditional CD and DVD format is that these technologies are becoming obsolete. This sentiment is especially prominent among the younger consuming public (ages 15-30), a population that has historically accounted for a disproportionately large percentage of sales of music and video related items.

If the entertainment industry wishes to regain its place as one of the more profitable sectors of the economy, the industry must eliminate the negative sentiment towards the CD and DVD format and the illegal sharing of artistic work.

In order to address these problems, the inventor invented the present invention, specifically a system and method of selectively distributing media content to consumers and preventing the unauthorized sharing of media content. The present invention is a system and method of selectively distributing media content to consumers and preventing the unauthorized sharing of media content, the system comprising essentially of a USB-type storage device loaded with media content, a network and a user interface system. The method comprises essentially of providing a USB-type storage device loaded with media content, distributing the device to retail outlets, instructing a user to contact a network that is in electronic communication with the USB-type storage device, selectively registering the media content on the network, activating the USB-type storage device, displaying the activated media content to the consumer on a display device associated with the user interface system, and providing a means to upload media content onto the USB-type storage device in the event the media content becomes corrupted or erased.

The present invention prevents the unauthorized sharing of media content with others, as only a registered user with an activation code can access the media content. The activation code is administered pursuant to a predetermined set of rules that limits the access of the media content to one user with certain identifying credentials; as such only the user with the specified set of credentials can access the media content, thereby preventing the media content from being shared with others. The identifying credentials might be specific to the user, i.e. user's date of birth, social security number, etc. or they might be specific to the user interface system, i.e. the IP address of the user's computer, etc.

Should the media content loaded onto the USB-type device become corrupted or erased, the user can log onto a network and upload the corrupted or erased media content by providing the user's identifying credentials.

An objective of the present invention, is to provide a system and method of selectively distributing media content to consumers and preventing the unauthorized sharing of media content in a convenient and user friendly format.

Another objective of the present invention, is to provide a system and method of selectively distributing media content to consumers in a manner that prevents the unauthorized sharing of the media content.

Another objective of the present invention, is to provide a system and method of selectively distributing media content to consumers and preventing the unauthorized sharing of media content in a manner that would allow the consumer to easily replace the media content should it become corrupted or erased.

Yet a further objective of the present invention, is to provide a system and method of selectively distributing media content to consumers and preventing the unauthorized sharing of media content that is cost effective to produce and maintain.

For the foregoing reasons there exists a need for a system and method of selectively distributing media content to consumers and preventing the unauthorized sharing of media content whereby the system comprises essentially of a USB-type storage device loaded with media content, a network and a user interface system and the method comprises essentially of providing a USB-type storage device loaded with media content, distributing the device to retail outlets, instructing a user to contact a network that is in electronic communication with the USB-type storage device, selectively registering the media content on the network, activating the USB-type storage device, displaying the activated media content to the consumer on a display device associated with the user interface system, and providing a means to upload media content onto the USB-type storage device in the event the media content becomes corrupted or erased.

### SUMMARY

The present invention is a system and method of selectively distributing media content to consumers and preventing the unauthorized sharing of media content, the system comprising essentially of a USB-type storage device loaded with media content, a network and a user interface system. The method comprises essentially of providing a USB-type storage device loaded with media content, distributing the device to retail outlets, instructing a user to contact a network that is in electronic communication with the USB-type storage device, selectively registering the media content on the network, activating the USB-type storage device, displaying the activated media content to the consumer on a display device associated with the user interface system, and providing a means to upload media content onto the USB-type storage device in the event the media content becomes corrupted or erased.

The present invention prevents the unauthorized sharing of media content with others, as only a registered user with an activation code can access the media content. The activation code is administered pursuant to a predetermined set of rules that limits the access of the media content to one user with certain identifying credentials; as such only the user with the specified set of credentials can access the media content, thereby preventing the media content from being shared with others. The identifying credentials might be specific to the user, i.e. user's date of birth, social security number, etc. or they might be specific to the user interface system, i.e. the IP address of the user's computer, etc. Should the media content loaded onto the USB-type device become corrupted or erased, the user can log onto a network and upload the corrupted or erased media content by providing the user's identifying credentials.

### DRAWINGS

These and other features, aspects, and advantages of the present invention will become better understood with regard to the following description, appended claims and drawings where:

FIG. 1 shows a schematic diagram of the method for selectively distributing media content to a consumer; and

FIG. 2 illustrates the process of selectively distributing media content to a consumer.

### DESCRIPTION

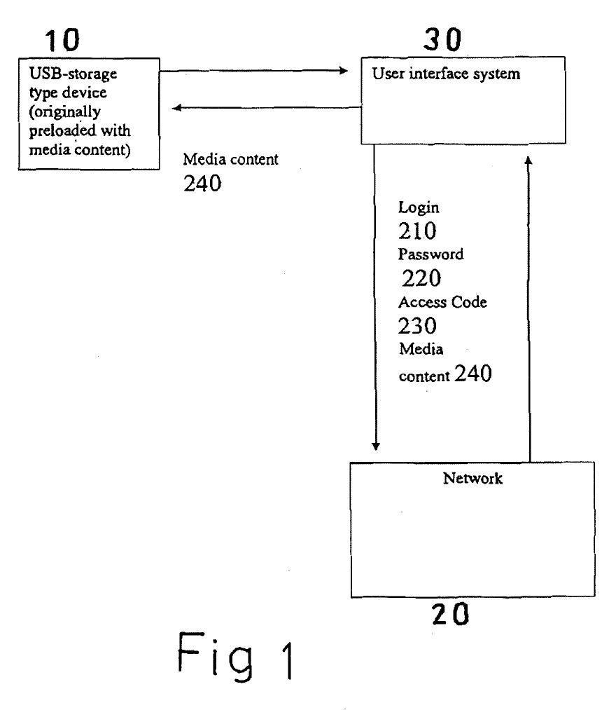

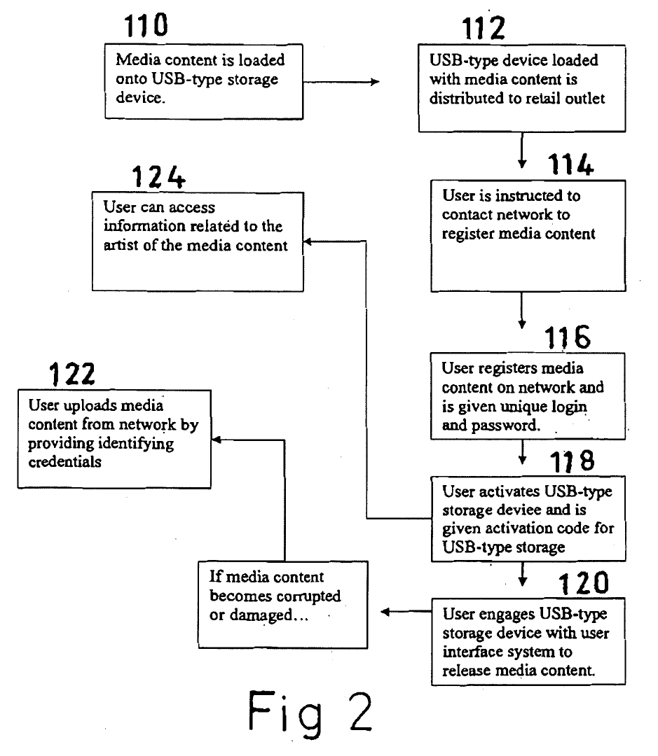

As shown in FIGS. 1-2, a system and method for selectively distributing media content to consumers and preventing the unauthorized sharing of media content. The system comprises essentially of a USB-type storage device 10, a network 20 and a user interface system 30. The method comprises essential of providing a USB-type storage device 10 loaded with media content 240, distributing the USB-type storage device 10 loaded with media content 240 to a retail outlet for retail sale, instructing a user to contact the network 20 to register the media content 240, selectively registering the media content 240 on the network 20, activating the USB-type storage device 10, releasing the activated media content 240 to the user via a display device associated with a user interface system 30, and providing a means to upload media content 240 onto the USB-type storage device 10 in the event the media content 240 becomes corrupted or erased.

The USB-type storage device 10 comprises a means for receiving and processing information from a network, and a means for communicating with a user interface system 30. The means for receiving and processing information might include wireless communication technologies, or other receiving and processing means known in the art. The information stored on USB-type storage device 10 includes media content that might include a full album of a musical artist's recordings in a digital format, a compilation of multiple full albums of a musical artist's recordings in a digital format, a single musical piece or a promotional compilation of musical pieces in a digital format, a ringtone in a digital format, a movie in a digital format, a compilation of movies in a digital format, a television series in a digital format, a compilation of television series in a digital format, or any combination thereof.

The essential features of the network 20 include a means for allowing multiple users to communicate electronically or otherwise with each other and providing a means for storing and accessing information to and from a device other than the user's user interface system 30 for selectively distributing media content 240 to a consumer and preventing the unauthorized sharing of media content 240. The network 20 comprises at least one server containing information directly related to the artist of the media content 240 and/or the media content 240 itself.

The user interface system 30 might include a personal computer, a laptop computer, a smart phone, or other interface system capable of communicating electronically or otherwise with a network 20 for selectively distributing media content 240 to a consumer and preventing the unauthorized sharing of media content 240.

As shown at step 110, media content 240 is loaded onto the USB-type storage device 10. The media content 240 might include a full album of a musical artist in a digital format, a compilation of multiple full albums of a musical artist in a digital format, a single musical piece or a promotional compilation of musical pieces in a digital format, a ringtone in a digital format, a movie in a digital format, a compilation of movies in a digital format, a television series in a digital format, a compilation of television series in a digital format, or any combination thereof. Each item of media content 240 has a predetermined identifier associated with it; the identifier might be an alphanumeric code.

As shown instep 112, the USB-type storage device 10, loaded with media content 240 is distributed to retail outlets for retail sale.

As shown in step 114 the user is instructed to contact the network 20 to register the media content 240. The user might be instructed to contact the network 20, via a point of sale terminal at the retail outlet, via a telephone communication, or through an internet connection.

As shown in step 116, the user must register the media content 240 onto the network 20. Registration is based on the identifier associated with the media content 240, the consumer is provided a user specific credentials that might be in the form of a login and password after successful registration. The login and password might be a combination of alphanumeric characters.

As shown in step 118, the user must activate the USB-type storage device 10 onto the network 20. The activation step 118 includes a means for providing an activation code unique to the USB-type storage device 10. The means for providing the activation code include the use of a terminal, telephone contact number or email contact for obtaining the unique activation code. The activation code is administered pursuant to a set of predetermined rules; including a proper verification of the user's credentials, proof of purchase of the device, and/or subscription to a predetermined service. The predetermined set of rules restricts access to the media content 240 only to the user with the appropriate predetermined credentials. The activation code might be a combination of alphanumeric characters.

As shown in step 120, the media content 240 loaded onto the USB-type storage device 10 is released to a user via a display device associated with the user interface system 30, after a valid login, password and activation code has been provided for the media content 240.

As shown in step 122, should the media content 240 on the USB-type storage device 10 become corrupted or erased, the media content 240 can be uploaded from the network 20 only after the user provides a valid login, password, and activation code for the media content 240.

As shown in step 124, the user is granted access to a server containing information directly related to the artist of the media content 240 and/or the media content 240 itself upon successful activation of the USB-type storage device 10. The information might include the artist's website, chat rooms, discussion forums, email addresses, promotional material, and/or list of tour dates.

An advantage of the present invention is that it provides a system and method of selectively distributing media content to consumers and preventing the unauthorized sharing of media content in a convenient and user friendly format.

Another advantage of the present invention is that it provides a system and method of selectively distributing media content to corners in a manner that prevents the unauthorized sharing of the media content.

Another advantage of the present invention is that it provides a system and method of selectively distributing media content to consumers and preventing the unauthorized sharing of media content in a manner that would allow the consumer to easily replace the media content should it become corrupted or erased.

Yet a further advantage of the present invention, is that it provides a system and method of selectively distributing media content to consumers and preventing the unauthorized sharing of media content that is cost effective to produce and maintain.

Although the present invention has been described in considerable detail with reference to certain preferred versions thereof, other versions are possible. Therefore, the spirit and the scope of the claims should not be limited to the description of the preferred versions contained herein.

What is claimed is:

1. A system for selectively distributing media content to a consumer and preventing the unauthorized sharing of media content comprising:
a. a USB-type storage device, the device comprises a means for receiving and processing information from a network, and a means for communicating with a user interface system, wherein the means for receiving and processing information might include wireless communication technologies and the information stored on the USB-type storage device is media content consisting of music, music videos, ringtones, movies, television episodes, television series, or interviews in a digital format;
b. a user interface system capable of receiving and processing information from a USB-type storage device and displaying media content for selectively distributing media content to a consumer whereby a user must selectively register media content on a network and activate the USB-type storage device prior to viewing or listening to the media content, the user interface system, when activated has the capacity to grant access to a server containing information directly related to an artist of the media content and/or the media content itself; and
c. a network capable of receiving and processing information from a user interface system for selectively distributing media content to a consumer, the network contains at least one server containing information directly related to an artist of the media content and/or the media content itself.

2. The system of claim 1, wherein a user is provided a user specific login and password from the network in order to register the media content.

3. The system of claim 2, wherein a user is provided a user specific activation code in order to activate the USB-type storage device.

4. The system of claim 3, wherein the USB-type storage device can be activated at a point of sale terminal.

5. The system of claim 3, wherein the USB-type storage device can be activated via a telephone.

6. The system of claim 3, wherein the USB-type storage device can be activated via an internet connection

7. The system of claim 3, wherein the user interface is a computer.

8. The system of claim 3, wherein the user interface is a smart phone.

9. A method of selectively distributing media content to a consumer and preventing the unauthorized sharing of media content comprising:
a. providing a USB-type storage device, the device comprises a means for receiving and processing information from a network, and a means for communicating with a user interface system, wherein the means for receiving and processing information might include wireless communication technologies;
b. loading a media content onto the USB-type storage device, the media content consists of music, music videos, ringtones, movies, television episodes, television series, or interviews in a digital format and at least one identifier associated with each media content item;
c. distributing the USB-type storage device loaded with media content to retail outlets for retail sale;
d. instructing a purchaser of the USB-type storage device to communicate with a predetermined network to selectively register the media content, the network comprises of at least one server containing information directly related to the artist of the media content and/or the media content itself;
e. selectively registering the media content on the network to protect the media content from unauthorized use, registration is based on the identifier associated with the media content, the consumer is provided a user specific login and password after successful registration;
f. activating the USB-type storage device, wherein the activation step might further comprise providing a means for obtaining an activation code whereby said means consists of a terminal, telephone contact number or email contact for obtaining an activation code and the activation code is administered pursuant to a set of predetermined rules; the user is granted access to the server containing information directly related to the artist of the media content or the media content once the USB-type storage device is activated;
g. releasing the media content loaded onto the USB-type storage device on a display device associated with the user interface system, whereby the media content can be accessed only after a valid login, password and activation code has been provided for the media content; and
h. providing a means for uploading media content onto the USB-type storage device should the media content become corrupted or erased, wherein the media content can be uploaded only after the user provides a valid login, password, and activation code for the media content.

10. The method of claim 9, wherein the predetermined rules of the activation step comprise a means for identifying the user thereby permitting only the user with the identified credentials access to the media content.

11. The method of claim 10, wherein the user interface system is a computer.

12. The method of claim 10, wherein the user interface system is a smart phone.

13. A method of selectively distributing media content to a consumer and preventing the unauthorized sharing of media content comprising:
a. providing a USB-type storage device, the device comprises a means for receiving and processing information from a network, and a means for communicating with a user interface system, wherein the means for receiving and processing information might include wireless communication technologies;
b. loading a media content onto the USB-type storage device, the media content consists of music, music videos, ringtones, movies, television episodes, television series, or interviews in a digital format and at least one identifier associated with each media content item;
c. distributing the USB-type storage device loaded with media content to retail outlets for retail sale;
d. instructing a purchaser of the USB-type storage device to communicate with a predetermined network to selectively register the media content, the network comprises of at least one server containing information directly related to the artist of the media content and/or the media content itself;
e. selectively registering the media content on the network to protect the media content from unauthorized use, registration is based on the identifier associated with the media content, the consumer is provided a user specific login and password after successful registration;
f. activating the USB-type storage device, wherein the activation step might further comprise providing a means for obtaining an activation code whereby said means consists of a terminal, telephone contact number or email contact for obtaining an activation code and the activation code is administered pursuant to a set of predetermined rules; the user is granted access to the server containing information directly related to the artist of the media content or the media content once the USB-type storage device is activated; and
g. releasing the media content loaded onto the USB-type storage device on a display device associated with the user interface system, whereby the media content can be accessed only after a valid login, password and activation code has been provided for the media content.

14. The method of claim 13, further comprising the step of providing a means for uploading media content onto the USB-type storage device should the media content become corrupted or erased, wherein the media content can be uploaded only after the user provides a valid login, password, and activation code for the media content.

15. The method of claim 14, wherein the predetermined rules of the activation step comprise a means for identifying the user thereby permitting only the user with the identified credentials access to the media content.

16. The method of claim 15, wherein the user interface system is a computer.

17. The method of claim 16, wherein the user interface system is a smart phone.
